(19) United States
(12) Patent Application Publication
(10) Pub. No.: US 2007/0131007 A1
(43) Pub. Date: Jun. 14, 2007

(54) Lock with actuation indicator

(76) Inventor: Dean D. Hacker, Oak Creek, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/637,409

(22) Filed: Dec. 12, 2006

Related U.S. Application Data
(60) Provisional application No. 60/749,561, filed on Dec. 12, 2005.

(51) Int. Cl. G07C 1/32; E05B 45/06

(52) U.S. Cl. 70/433; 340/542

(57) ABSTRACT

A lock includes an actuation indicator that displays a unique actuation identifier. The actuation identifier changes with each actuation of the lock to provide an indication that the lock has been actuated.

### CROSS REFERENCE TO RELATED APPLICATION

This application claims the benefit of United States Provisional Patent Application No. 60/749,561, entitled “LOCK WITH OPERATION INDICATOR” and filed Dec. 12, 2005, the entire disclosure of which is hereby incorporated by reference.

### FIELD OF INVENTION

The invention relates to locking devices and to the inclusion of an indicator with the locking device to determine if the locking device has been operated.

### BACKGROUND

Locks and other securing devices are employed to secure all types of objects, containers, and spaces against unauthorized use. Locks are typically unlocked through the use of a key, combination, code, or other such authorizing mechanism. Many of these mechanisms allow for several people to have the ability to open the lock. For instance, keys can be duplicated and combinations can be memorized or recorded, such that multiple people can open a given lock. When a key is duplicated or several people have knowledge of a combination, it is difficult for an authorized user of the lock to determine if the lock has been opened without authorization since the lock was last closed.

It is desirable to develop methods and apparatus through which an authorized user can determine if a lock has been operated since the last authorized use of the lock.

### SUMMARY

A lock that features an actuation indicator includes a lock body and a lock mechanism actuable between a locked and an unlocked condition. The lock mechanism includes a shackle that is movable relative to the lock body between a closed position corresponding to the locked condition in which the shackle is fixed in position with respect to the lock body and an open position corresponding to the unlocked condition in which the locking member is moveable with respect to the lock body. A lock sensor is configured to sense actuation of the lock mechanism and to send a trigger signal indicative of actuation of the lock mechanism. An actuation identifier generator in signal communication with the locking member sensor generates an alphanumeric actuation identifier in response to the trigger signal. The actuation identifier can be, for example, a random number or set of alphanumeric characters, or a serial number. The lock may include a display that displays the actuation identifier and actuation identifier recorder with memory storage for storing a succession of actuation identifiers and associated times and dates of actuation.

### DESCRIPTION OF DRAWINGS

In the accompanying drawings, which are incorporated in and constitute a part of this specification, embodiments of the invention are illustrated, which, together with a general description of the invention given above, and the detailed description given below serve to illustrate the principles of this invention. The drawings and detailed description are not intended to and do not limit the scope of the invention or claims in any way. Instead, the drawings and detailed description only describe embodiments of the invention and other embodiments of the invention not described are encompassed herein.

FIG. 1 is a perspective view of a lock constructed in accordance with an embodiment of the present invention;

FIG. 2 is a cross-sectional view of the lock of FIG. 1, illustrating a locking mechanism;

FIG. 3 is a front elevation view of the lock of FIG. 1, showing the lock in an open position;

FIG. 4A is front elevation view of the lock of FIG. 1, showing the lock in a closed position and displaying an identifier on a digital display;

FIG. 4B is a front elevation view of the lock of FIG. 1, showing the lock in the open position and displaying an identifier on the digital display;

FIG. 4C is front elevation view of the lock of FIG. 1, showing the lock in the closed position and displaying an identifier on the digital display;

FIG. 5A is a perspective view of the lock of FIG. 1, showing the digital display unilluminated;

FIG. 5B is a perspective view of the lock of FIG. 1, showing the digital display illuminated;

FIG. 6 is a flow diagram of a method of using the lock of FIG. 1;

FIG. 7 is a cross section view of the lock of FIG. 1; and

FIG. 8 is a schematic diagram of an exemplary control system for the lock of FIG. 1.

### DETAILED DESCRIPTION

The Detailed Description of the invention merely describes embodiments of the invention and is not intended to limit the scope of the claims in any way. Indeed, the invention is broader than and unlimited by the disclosed embodiments and the language used in this specification, and the terms used have their full ordinary meaning.

An embodiment of the invention provides for a lock including a locking mechanism, a sensing arrangement, a circuit, and a display. The locking mechanism is operable to selectively lock and unlock the lock. The sensing mechanism senses when the lock is operated. The circuit generates an identifier each time the sensing arrangement senses the locking mechanism is operated, and the display reveals the identifier each time one is generated.

The invention will be described using a padlock. It should be understood this is for exemplary purposes only and the invention may be practiced with other types of locking mechanisms, such as for example, combination locks.

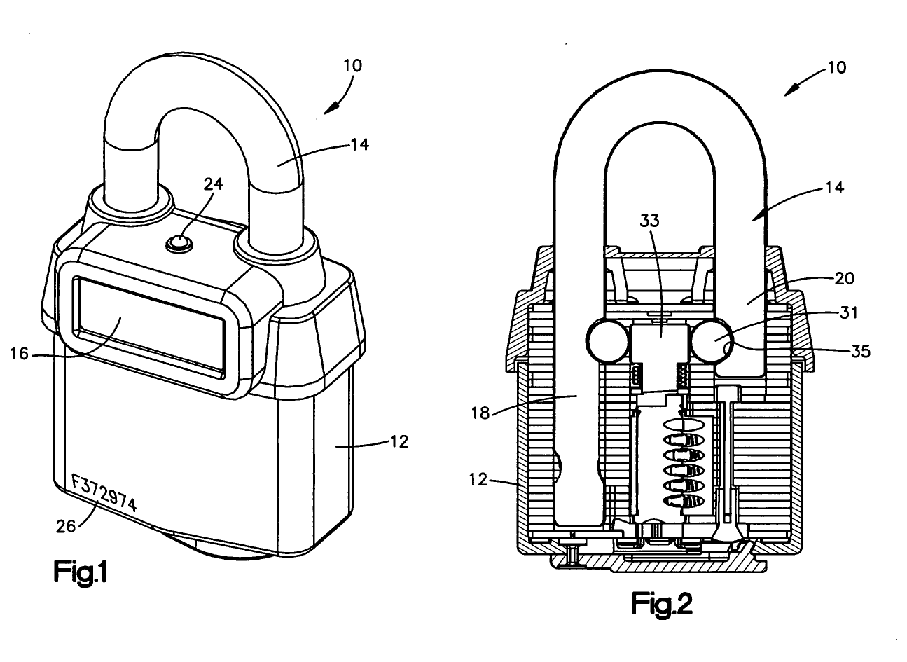

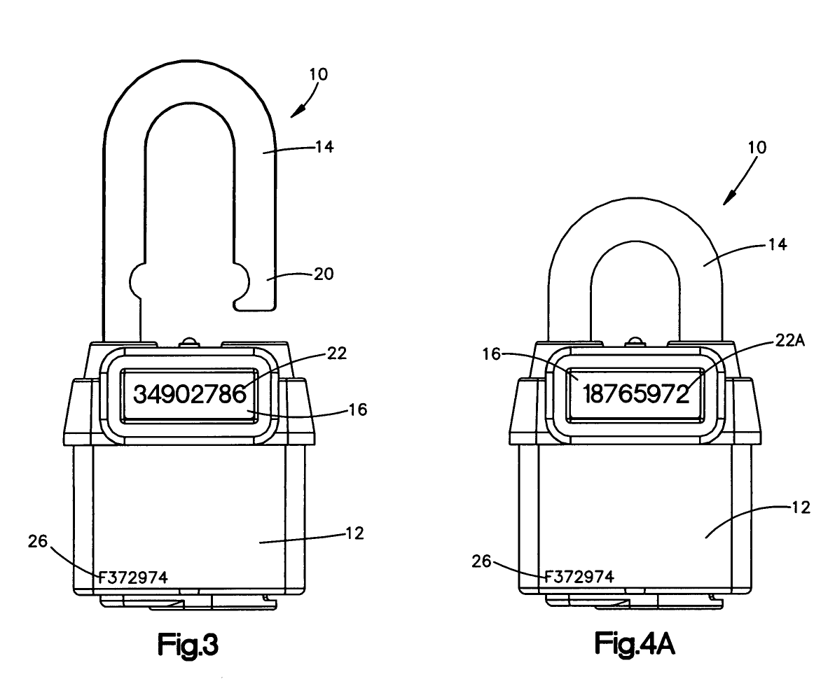

As shown in FIG. 1, a lock 10 includes a lock body 12, a shackle 14, and a digital display 16. The lock 10 also includes an actuation identifier generator (FIG. 8)located inside the lock body 12. The lock 10 operates between open and closed positions. The shackle 14 is moveably coupled to the lock body 12 such that the lock 10 can move between the open and closed positions. As best seen in FIG. 2, the shackle 14 includes a long leg 18 and a short leg 20. The lock 10 can move from a closed position to an open position by moving the shackle 14 upwards (with respect to FIGS. 1 and 2) until the short leg 20 exits the lock body 12, as shown in FIG. 3. The lock 10 can be move from the open position to the closed position by moving the shackle 14 downwards (with respect to FIGS. 1, 2, and 3) until the short leg 20 of the shackle 14 is inserted into the lock body 12, as shown in FIG. 2.

The lock 10 includes a locking mechanism by which the lock 10 can be locked and unlocked. The lock 10 generally needs to be unlocked for the shackle 14 to be moved from a closed position (shown in FIG. 1 and 2) to an open position (shown in FIG. 3). The lock 10 can be arranged such that the shackle 14 can be moved from the open position to the closed position only when the lock 10 is unlocked. Alternatively, the lock 10 can be arranged such that the shackle 14 can be moved from an open position to a closed position when the lock 10 is either locked or unlocked.

The locking mechanism can be operated by inserting a key (not shown) into a key slot in a key cylinder (not shown). Typically, turning the key in a first direction unlocks the lock 10 and turning the key in a second and opposite direction locks the lock 10. When the lock 10 in closed and locked, turning the key to unlock the lock 10 rotates a keeper 33 to release a pair of shackle retaining balls 31 and allow the shackle 14 to be moved upwards to open the lock 10. As described above, the lock 10 can be arranged such that the key generally must maintain the locking mechanism in the unlocked state for the shackle 14 to move from an open to a closed position. Alternatively, the lock 10 can be arranged such that the locking mechanism may be in either an unlocked or a locked state for the shackle 14 to be moved from on open position to a closed position.

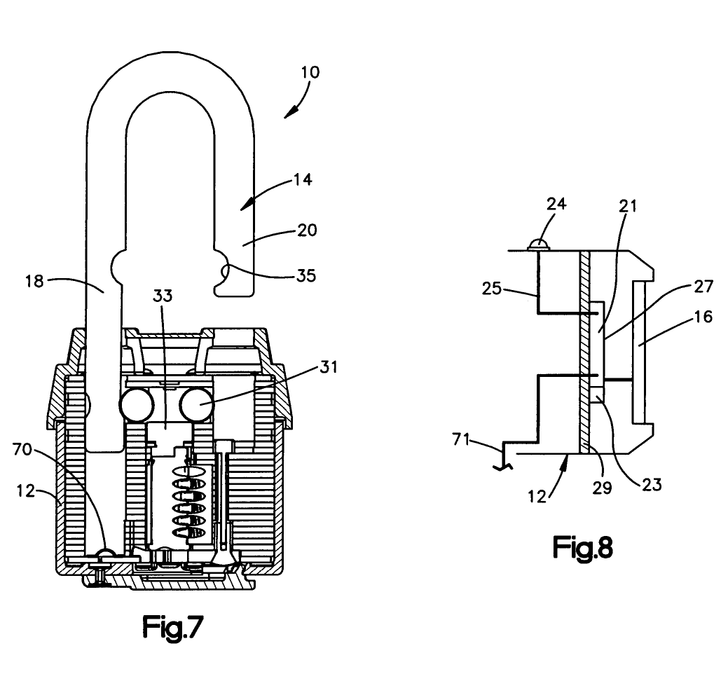

As shown in detail in FIG. 7, a sensor 70 is mounted in the lock body 12 to sense when the lock 10 is operated. The sensor 70 can be a mechanical switch that is closed by contact with, for example, a leg of the shackle, or the shackle balls (not shown). The sensor 70 can be a photoelectric sensor that senses a proximity of, for example, a leg of the shackle without mechanical contact. The switch or sensor can be arranged to sense one or more different movements within the lock 10 that indicate operation. For example, a switch or sensor can be arranged to sense when the lock 10 moves from an open position to a closed position, or a switch or sensor can be arranged to sense when the lock 10 moves from a closed position to an open position. In addition, the switch or sensor can be arranged to sense any change in the state of the lock 10. Such changes in state include, for example, the shackle 14 moving from an open position to a closed position, the shackle 14 moving from a closed position to an open position, the lock 10 being unlocked, the lock 10 being locked, or the lock 10 being sufficiently tampered with in an attempt to pick the lock 10.

The switch or sensor 70 can use a variety of methods in determining that the state of the lock 10 has changed. For example, the switch or sensor 70 can be positioned to sense movement of the shackle 14 during opening or closing of the lock 10. The movement detected can be either upward movement of the shackle 14, downward movement of the shackle 14, rotational movement of either shackle leg 18, 20, lateral movement of the shackle, or any other movement of the shackle 14. Alternatively, the switch or sensor can be positioned to sense operation of the locking mechanism. The operations detected can be the insertion of a key or other object into a key slot or the turning of a key in the key slot. These movements and operations of the lock 10 can be sensed through a variety of methods. For example, a mechanical switch can be used. Alternatively, a photoelectric sensor can be positioned proximate to a shackle 14 to determine movement of the shackle 14 through changes in light waves or electrical current caused by the movement of the shackle 14. Similarly, a photoelectric sensor can be positioned proximate to the locking mechanism to sense the insertion of a key or other object or the turning of a key. In addition to the embodiments described, this invention includes the use of any other switch or sensing mechanism known in the art that can sense a change in state of the lock 10 or movement of components in the lock 10.

Referring to FIG. 8, a schematic cross section of a display portion of the lock body 12 is shown. The display portion houses a circuit board 29 that includes an integrated circuit 21, or set of integrated circuits, that is capable of driving the display 16. The integrated circuit includes an actuation identifier generator 23 that generates a unique actuation identifier, such as a random combination of alphanumeric characters or a serial number, in response to a trigger signal on lead 71. When the switch or sensor 70 has sensed that the lock 10 had been operated, the switch or sensor 70 generates a trigger signal on an associated trigger lead 71 indicating that the lock 10 has been operated. This signal is inputted to the integrated circuit and triggers the actuation identifier generator 23 to generate a new actuation identifier. The actuation identifier is displayed on the display 16. A display illumination button 24 may also provide an input to the integrated circuit 21 that enables display of the actuation identifier for a limited duration of time to conserve power consumption. The displayed actuation identifier can be used by a user of the lock 10 to identify a particular instance of the lock 10 being operated. An actuation identifier recorder 27 is also included as part of the integrated circuit 21. As will be described below, the recorder provides a memory function to the lock.

Some of the components described above require electric power in order to operate correctly. A battery contained in the lock body 12 can supply this power. This battery can provide power to several components, including the switch or sensor, which senses change of state of the lock 10 and relays signals to other components in the lock 10; the integrated circuit, the actuation identifier generator; the actuation identifier recorder; and the digital display 16, which reveals the identifier 22.

The actuation identifier recorder 27 provides for the storage of the actuation identifier associated with the current state of the lock 10, along with storage of past actuation identifiers associated with past states of the lock 10. In addition to generating an actuation identifier and relaying the number to the digital display 16, the actuation identifier can be stored in the memory function so that it can be retrieved if the digital display 16 malfunctions. In addition, the actuation identifier recorder can retain an index of all actuation identifiers generated so that a user can determine information other than if lock 10 had been previously operated, such as for example, the number of times it has been operated.

A time stamp can be associated with each actuation identifier generated and stored in the recorder 27. This feature allows a user to determine the date and time that each lock 10 operation occurred. The actuation identifier recorder can include other information important to an authorized user. For example, the actuation identifier recorder can include information related to the type and quantity of goods in a secured container or the point of origin and destination of the container. Alternatively, the actuation identifier recorder can reside on a separate circuit from the actuation identifier generator 23. Optionally, the lock 10 can include a data port (not shown), such as for example, a universal serial bus (USB), parallel port, or serial port to upload and download information from integrated circuits, the system board, or the digital display 16.

The digital display 16, as shown, is a liquid crystal display (LCD). However, any mechanism known in the art for displaying an identifier is included in this invention. For example, the digital display can be a series of light emitting diodes (LED). Alternatively, the display may be mechanical as opposed to digital, such as for example, a series of mechanically or electrically driven wheels or tumblers. Although the exemplary illustration shows an eight digit number as the product of the random number generator, it should be understood that a set of numbers of any length can be produced by an integrated circuit and displayed on a digital display. In addition, the characters generated and displayed are not limited to numbers. The characters could be any symbols, such as for example, upper and lower case letters, ampersands, asterisks, and the like.

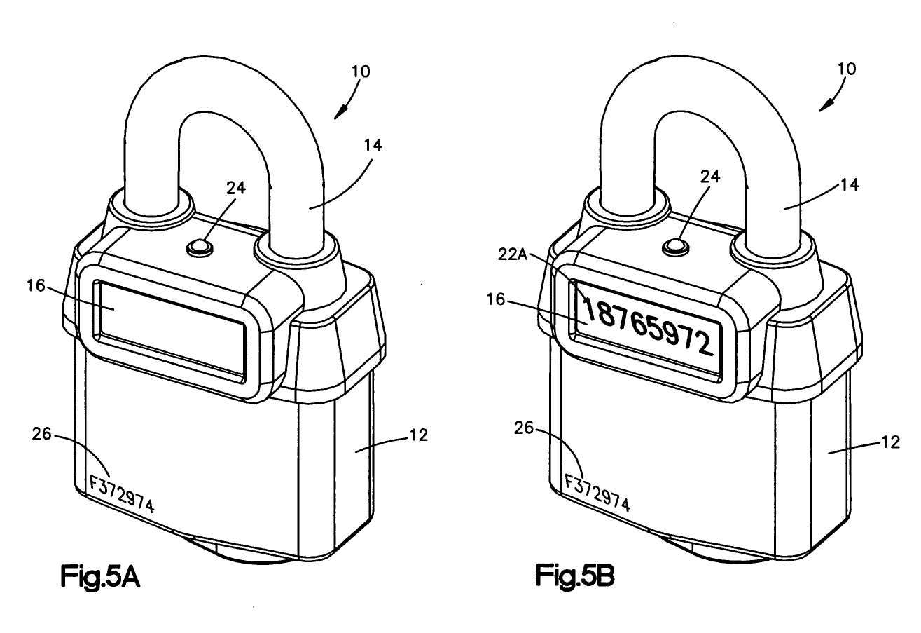

The battery life can impact the performance and usefulness of the lock 10. Therefore, efficiencies and conservation methods that prolong battery life are useful. For instance, the digital display 16 can be arranged so that the identifier 22 is selectively displayed. To continuously display an actuation identifier 22 when it is normally only read shortly after a lock 10 is closed and shortly before a lock 10 is opened is inefficient use of battery power. The integrated circuit or display 16 can be arranged such that the actuation identifier 22 is shown on the display 16 for only a period of time after the actuation identifier is generated. This period of time can be selected such that it is long enough for a user to note the actuation identifier generated. As best shown in FIGS. 5A and 5B, an illuminating button 24 can be added to re-illuminate the digital display 16 once the period of time has expired. The actuation identifier can be retained by the digital display 16 or retrieved from the actuation identifier recorder when the illuminating button 24 is pressed. FIG. 5A shows the lock 10 after the display period has expired. FIG. 5B shows the lock 10 with in the display period after the illuminating button 24 has been depressed. With this arrangement, a user can depress the button 24 prior to opening the lock 10 to view the last actuation identifier generated 22 and compare the displayed actuation identifier 22 with the identifier associated with the last authorized closing of the lock 10.

One embodiment of an actuation identifier generator 23 is a random number generator that can be designed to generate, at random, a series of numbers or other characters to produce a generally unique identifier. Electronic random number generators are known in the art. In an embodiment of the invention, the generation of a random number or identifier is initiated by the electronic input signal on lead 71 from the switch or sensor 70, produced when the lock 10 has been operated. Once this random number is generated, the identifier can be provided or revealed to a user of the lock 10. The user can record or remember the number and associate that number with the specific instance of the operation of the lock 10. This operation can be associated with a unique time, location, or event, or combination thereof.

As shown in FIG. 3, one method of providing a user with the randomly generated number or identifier is to display the identifier 22 on a digital display 16. The digital display 16 can be in electronic communication with the integrated circuit, such that each time a number is generated in response to the operation of the lock, the identifier 22 shown on the digital display 16 updates to correspond with the random number generated for that specific operation of the lock 10.

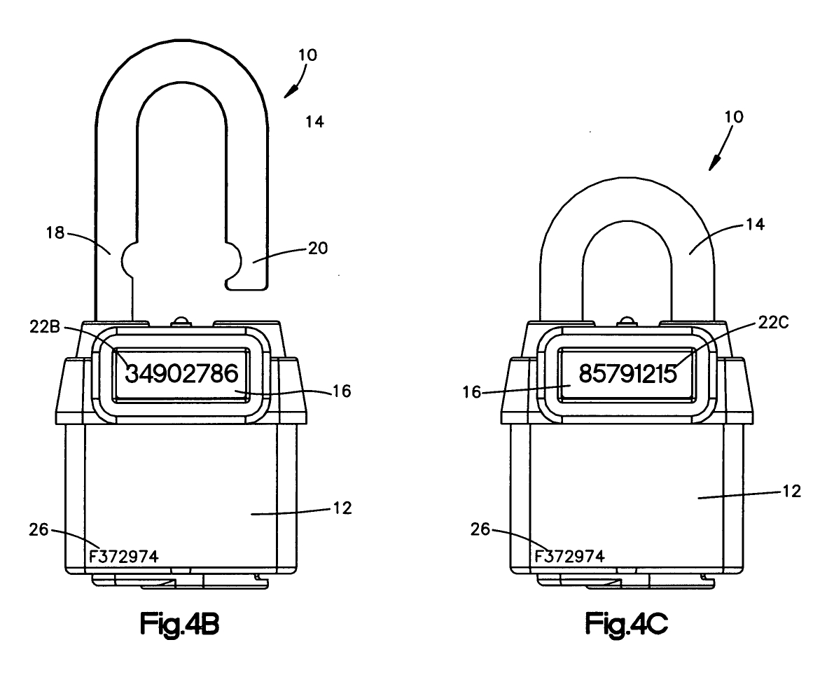

An arrangement where a random number is generated for each opening and closing of the shackle 14 is shown in FIGS. 4A, 4B, and 4C. In FIG. 4A, the lock 10 is shown in a closed position, with the digital display 16 showing a first number 22A generated the last time the lock 10 was closed. FIG. 4B shows the lock 10 now in an open position, with the digital display 16 showing a second number 22B generated when the lock 10 is opened, which is used to identify that instance of the lock 10 being opened. FIG. 4C shows the lock 10 again closed, with a third number 22C generated when the lock 10 is again closed, which is used to identify that instance of the lock 10 being closed.

The random number generator is described as an integrated circuit. It should be understood that a random number can be generated by a variety of means. For instance, random numbers can be generated by the rotation of mechanical wheels or tumblers. Any method or means of generating a random number or identifier is incorporated into this invention.

The apparatus and functionality as described above can be used in a variety of circumstances to determine if a lock 10 has been operated since the last authorized use of the lock 10. One such circumstance is common to the shipping and carrier industries. In these industries, it is common for goods and inventory to be shipped significant distances in trucks, railcars, cargo ships, and the like. During shipping, goods are often secured within shipping containers. Between the origination point and the final destination, these containers may be passed through a chain of custody that includes local transporters, customs officials, distributors, consolidators, and warehousers. To discourage theft during the transportation from manufacturer to final destination, these containers are often locked with keyed padlocks. Although containers are locked, theft can still occur if the container is unlocked by an unauthorized person. Sometimes theft from shipping containers or of shipping containers is hard to detect. However, such unauthorized access can be detected through the use of the lock 10 as described above.

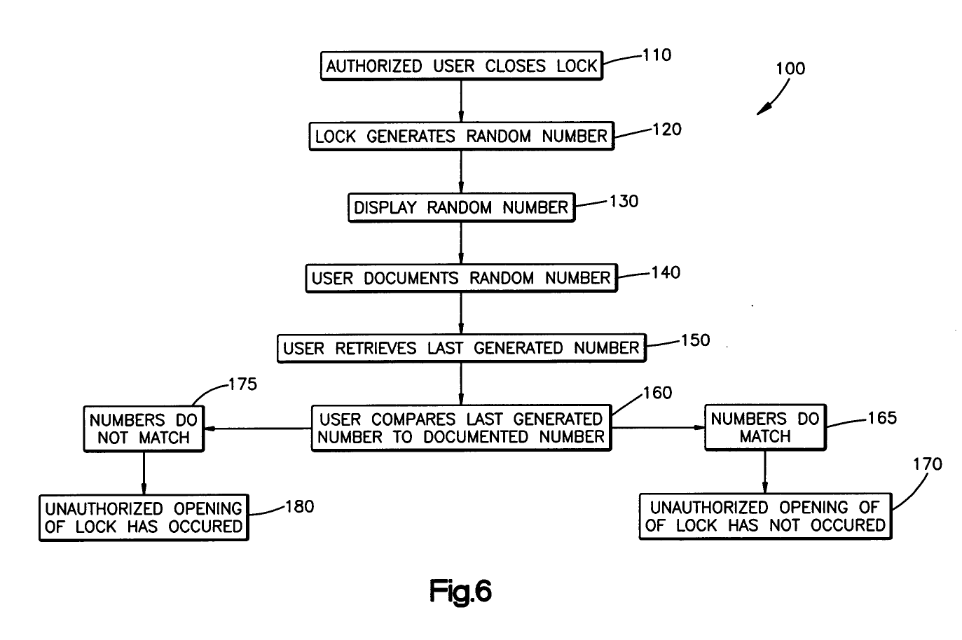

A method of using the lock 10, as described, is illustrated in FIG. 6. The lock 10 can be arranged such that each time the lock 10 on a container is closed, the switch or sensor senses the closing of the lock 10 and sends a signal to the integrated circuit to generate a new actuation identifier. Each time the lock 10 is opened and closed for an authorized purpose a new actuation identifier is generated. This number can be documented on the paperwork accompanying the container. Each time the container is reopened by an authorized user, the user can check the number 22 displayed by the digital display 16 against the actuation identifier documented in the paperwork to determine if there has been an unauthorized opening of the lock 10 since the last authorized user closed the lock 10. If the displayed actuation identifier 22 matches the documented number, there has not been an unauthorized opening of the lock 10. If the actuation identifiers differ, there is likely to have been an unauthorized opening of the lock 10. This process can be repeated each time the lock 10 is opened by an authorized user from the origination of the shipment to the shipment's final destination.

An additional security measure is the inclusion of a unique serial number 26 on the lock 10, as best seen in FIG. 3. This allows the user to confirm that the specific lock being inspected matches the specific lock documented on the paperwork accompanying the container. Additional security measures include visual and audio alarms that indicate that the lock has been opened.

While various aspects of the invention are described and illustrated herein as embodied in combination in the exemplary embodiments, these various aspects may be realized in many alternative embodiments not shown, either individually or in various combinations and sub-combinations thereof. Unless expressly excluded herein all such combinations and sub-combinations are intended to be within the scope of the present invention. Still further, while various alternative embodiments as to the various aspects and features of the invention, such as alternative materials, structures, configurations, methods, devices, and so on may be described herein, such descriptions are not intended to be a complete or exhaustive list of available alternative embodiments, whether presently known or later developed. Those skilled in the art may readily adopt one or more of the aspects, concepts or features of the invention into additional embodiments within the scope of the present invention even if such embodiments are not expressly disclosed herein. Additionally, even though some features, concepts or aspects of the invention may be described herein as being a preferred arrangement or method, such description is not intended to suggest that such feature is required or necessary unless expressly so stated. Still further, exemplary or representative values and ranges may be included to assist in understanding the present invention however; such values and ranges are not to be construed in a limiting sense and are intended to be critical values or ranges only if so expressly stated.

I claim:

1. A lock comprising:
a lock body;
a lock mechanism actuable between a locked and an unlocked condition comprising a shackle that is movable relative to the lock body between a closed position corresponding to the locked condition in which the shackle is fixed in position with respect to the lock body and an open position corresponding to the unlocked condition in which the shackle is moveable with respect to the lock body;
a lock sensor that is configured to sense actuation of the lock mechanism and to send a trigger signal indicative of actuation of the lock mechanism; and
an actuation identifier generator in signal communication with the lock sensor that generates an actuation identifier in response to the trigger signal.

2. The lock of claim 1 wherein the actuation identifier generator is a random number generator.

3. The lock of claim 1 further comprising a display in communication with the actuation identifier generator that displays the actuation identifier.

4. The lock of claim 1 further comprising an actuation identifier recorder that includes storage medium in communication with the actuation identifier generator that stores the actuation identifier.

5. The lock of claim 4 wherein the actuation identifier recorder includes storage medium for storing a succession of actuation identifiers.

6. The lock of claim 5 wherein the actuation identifier recorder includes a time and date generator that associates a time and date of occurrence with each actuation identifier.

7. The lock of claim 1 wherein the shackle is made of flexible cut resistant cable.

8. The lock of claim 1 wherein the shackle is made of rigid cut resistant material.

9. The lock of claim 1 comprising an alarm in signal communication with the shackle sensor that generates a perceptible alert in response to receiving the trigger signal.

10. The lock of claim 9 wherein the alert is audible.

11. The lock of claim 9 wherein the alert is visible.

12. The lock of claim 2 comprising a display button mounted on the body that is in signal communication with the display and wherein the display displays the actuation identifier for a predetermined period of time in response to actuation of the display button.

13. The lock of claim 1 wherein the lock sensor is a shackle sensing switch mounted within the lock body that is configured to change status in response to movement of the shackle to generate the trigger signal.

14. The lock of claim 13 wherein the shackle sensing switch is a mechanical switch that is contacted by the shackle when the shackle is placed in the closed position.

15. The lock of claim 13 wherein the shackle sensing switch is a photoelectric sensor mounted within the body that senses a proximity of the shackle when the shackle is moved to the closed position.

16. The lock of claim 1 wherein the lock body encloses one or more shackle balls that selectively retain the shackle in the closed position and wherein the lock sensor is a shackle ball sensing switch mounted within the lock body that is configured to change status in response to a change in position of the shackle balls when the shackle is placed in the closed position.

17. A method that provides a discernible indication of actuation of a lock that includes a shackle selectively retained within a lock body, wherein the shackle is selectively moveable along a shackle travel path between a locked and an unlocked position within the body, the method comprising:
sensing a position of the shackle;
generating a trigger signal when the shackle moves to a predetermined position;
generating a unique actuation identifier in response to the trigger signal; and
displaying the unique actuation identifier on the body in response to the trigger signal.

18. The method of claim 17 wherein the step of sensing a position of the shackle is performed by placing a switch within the shackle travel path as the shackle moves from the locked to the unlocked position.

19. The method of claim 17 wherein the step of generating a unique actuation identifier is performed by triggering a random number generator to generate the unique actuation identifier.

20. The method of claim 17 wherein the step of generating a unique actuation identifier is performed by triggering a counter to generate a serial actuation identifier.
